(19) United States
(12) Patent Application Publication
(10) Pub. No.: US 2013/0270949 A1
(43) Pub. Date: Oct. 17, 2013

(54) PERMANENT MAGNET ELECTRIC MACHINE WITH TWO PART OR MULTI PART PERMANENT MAGNETS

(71) Applicant: ROBERT BOSCH GMBH, Stuttgart (DE)

(72) Inventors: Mercedes Herranz Gracia, Tauberbischofsheim (DE); Armin Ploeger, Hildesheim (DE); Tilman Miehle, Waiblingen (DE); Karsten Kirchhoff, Sehlem (DE); Johannes Horn, Hannover (DE)

(21) Appl. No.: 13/864,150

(22) Filed: Apr. 16, 2013

(30) Foreign Application Priority Data
Apr. 16, 2012 (DE) 10 2012 206 149.5

(51) Int. Cl. H02K 1/02

(52) U.S. Cl. CPC H02K 1/02
USPC 310/152

(57) ABSTRACT

A permanent magnet electric machine (2), in which permanent magnets (7) are arranged on a stator (13) and/or a rotor (15). In this case, a permanent magnet (7) has at least one first macroscopic permanent magnet element and one second macroscopic permanent magnet element (21, 23), wherein the permanent magnet elements (21, 23) are formed from different materials, which have different magnetic coercitivities.

### BACKGROUND OF THE INVENTION

The present invention relates to a permanent magnet electric machine, in which strong permanent magnets are arranged on a stator and/or a rotor.

Electric machines with a high power are often used, for example in the form of synchronous machines, as motors or generators in electric or hybrid drives for motor vehicles. Alternatively, electric machines are often used as generators in wind energy installations. The electric machine in this case has a fixed stator and a rotor, which can rotate relative to this stator about an axis of rotation.

In order to be able to generate high forces with an electric machine when it is used as a motor or in order to be able to generate high electric currents with the electric machine when it is used as a generator, strong magnetic fields need to be produced within the electric machine. In permanent magnet electric machines, strong permanent magnets are provided on the rotor or on the stator for this purpose.

For example, DE 10 2009 029 274 A1 describes a permanent magnet synchronous machine in which strong permanent magnets are provided in the rotor.

Strong permanent magnets are often produced from expensive materials, such as rare earths, for example, and therefore contribute considerably to the total costs of the electric machine.

The permanent magnet electric machine proposed herein in its embodiments enables a considerable cost reduction in comparison with conventional permanent magnet electric machines.

### SUMMARY OF THE INVENTION

The invention proposes forming permanent magnets which are arranged on a stator and/or a rotor of a permanent magnet electric machine with at least one first macroscopic permanent magnet element and one second macroscopic permanent magnet element. The two or more permanent magnet elements are in this case intended to be formed from different materials, which have different coercivities.

The permanent magnet electric machine according to the invention can be considered as being based on the following incites and concepts, inter alia:

One objective with the development of electric machines is generally to reduce costs whilst retaining the same power, as far as possible, inter alia. In the case of permanent magnet electric machines, the material costs generally make up up to 80% of the total costs, i.e. only approximately 20% of the total costs are accounted for by the manufacture. Costs for the magnet material of the permanent magnets are one of the greatest factors within the material costs. Here, the costs for the magnet material are generally determined by the proportion of rare earths contained therein and the nature of the rare earth materials contained therein. In general, it can be assumed that the magnet material used is more cost intensive the higher the magnet coercivity of said material at high temperatures is.

In this case, the magnetic coercivity is understood to mean the magnetic field strength that is required for completely demagnetizing a ferromagnetic substance, with the result that the resulting total magnetic flux or the local magnetic flux density are equal to zero. The higher the coercivity, the better a magnet retains its magnetization when it is subjected to an opposing magnetic field.

Typically, it is also true that the lower the magnetic remanence, the higher the coercivity. Magnetic remanence can be understood in this case to mean the remanent magnetization or residual magnetization which an object which has previously been magnetized by an external magnetic field retains once the external field has been removed. Since the magnetic remanence can represent a measure of the strength of a magnet, it is generally true that materials which have a high magnetic coercivity produce a weaker permanent magnetic field than materials with a lower magnetic coercivity.

During operation of an electric machine, the magnetic properties of the permanent magnets used therein are utilized differently. It has been identified, for example, that there are regions in the electric machine in which there is a high risk of demagnetization of the permanent-magnetic material arranged there. Since the magnetic fields produced in such demagnetization critical regions are often particularly important for achieving high efficiency of the electric machine, permanent magnets which have a high coercivity are usually used, in particular in electric machines with which high powers are intended to be realized.

However, as a result the costs of the electric machine increase considerably. In addition, owing to the high magnetic coercivity of the material used, although the risk of local demagnetization is reduced, a magnetic field strength produced by such permanent magnets can be lower than when using permanent magnets with a relatively low magnetic coercivity.

In the light of this knowledge, it is therefore proposed to form the permanent magnets used in an electric machine at least in two parts, possibly only also in a plurality of parts. The materials used for the two permanent magnet elements are in this case intended to differ in terms of the coercivities effected thereby.

The permanent magnet elements should in this case have macroscopic dimensions, i.e. a volume of more than 1 mm3, preferably more than 10 mm3, for example.

Owing to the provision of such a permanent magnet in at least two parts in an electric machine, magnetic properties produced by the permanent magnet elements can be matched to respective requirements prevailing locally within the electric machine. For example, high grade and therefore expensive magnet material with a high coercivity can be used in particular where it is required owing to the functional requirements of the electric machine. In regions with relatively low requirements, for example in terms of coercivity, correspondingly cheaper materials with higher remanence can be used.

The electric machine can have demagnetization critical regions in which, during operation of the machine, there is an increased probability of demagnetization of a permanent magnet, for example owing to a high local temperature and/or strong magnetic fields. A demagnetization critical region can in this case in particular be understood to mean a region in which, during normal operation of the electric machine, such high temperatures and/or magnetic fields can prevail that demagnetization can occur which significantly impairs the performance of the electric machine in the case of a less demagnetization resistant magnet material, as can be used, for example, for the second permanent magnet elements, within the life of the electric machine. A permanent magnet which is arranged partially in such a demagnetization critical region can then have a first permanent magnet element consisting of a material with a relatively high magnetic coercivity in the demagnetization critical region and a second permanent magnet element consisting of a material with a relatively low magnetic coercivity outside the demagnetization critical region.

Positions at which demagnetization critical regions are located in a specific electric machine can in this case be determined, for example, by measuring a local temperature distribution within the electric machine and/or measuring a local distribution of the magnetic field strength and in particular by changes in the magnetic field strength during operation of the electric machine. Alternatively, the demagnetization critical regions can sometimes also be determined or at least estimated with the aid of simulations. The occurrence of regions in which particularly high temperatures occur or particularly strong or severely fluctuating magnetic fields prevail during operation of the electric machine can in this case be very dependent on the geometrical and electrical design of the electric machine.

It has been identified, for example, that in the case of electric machines in which typically there is an air gap between the stator and the rotor and permanent magnets are arranged in the vicinity of this air gap, a region which is close to the air gap is generally more demagnetization critical than a region further removed from the air gap. In regions close to the air gap, the permanent magnet can therefore have a first permanent magnet element consisting of a material with a relatively high magnetic coercivity, whereas the permanent magnet in the region further removed from the air gap can have a second permanent magnet element consisting of a material with a relatively low magnetic coercivity.

In order to form strong permanent magnets, for many years ferromagnetic materials have been used which contain rare earth materials. For example, very strong permanent magnets can be produced using neodymium iron boron compounds (NdFeB), as are used in electric machines for producing high power densities for example for use in vehicle drives or wind turbines. It has been identified that a coercivity can be increased in the case of such magnet materials by admixing dysprosium (Dy).

However, dysprosium is comparatively expensive. It is therefore proposed merely to provide the first permanent magnet element to be arranged in demagnetization critical regions with sufficient dysprosium in order to significantly increase the magnetic coercivity that can be achieved there and to form the second permanent magnet element to be arranged in the less demagnetization critical or non demagnetization critical regions with magnet material which does not contain any dysprosium or which contains so little dysprosium that it does not significantly increase the magnetic coercivity. “A significant increase in the coercivity” can in this case be understood to mean, for example, an increase in the coercivity owing to the admixed dysprosium by more than 10%, preferably more than 20%, in comparison with the same magnetic basic material to which no dysprosium has been admixed.

The first permanent magnet element which is intended to contain high grade, expensive magnet material can generally have a smaller volume than the second permanent magnet element. In this case, use can advantageously be made of the fact that the demagnetization critical regions within the electric machine are usually comparatively small and it is sufficient to arrange correspondingly small first permanent magnet elements of high quality only in these small regions. For example, the first permanent magnet element can have less than 30%, preferably less than 10% of the volume of the second permanent magnet element.

The first and second magnets can be connected fixably to one another. For example, the two permanent magnet elements can be adhesively bonded to one another. In this case, the two permanent magnet elements can be connected to one another as early as before being installed in the electric machine, with the result that they can be handled easily as one unit during installation. Alternatively, the two permanent magnet elements can be arranged individually in the electric machine and only then connected to one another. For this purpose, the two permanent magnet elements can be surrounded, for example, using a curable material, such as epoxy resin, for example, and thus both connected to one another and fixed within the electric machine.

In a conventional configuration, the electric machine has cutouts in the rotor and/or in the stator, which cutouts are sometimes also referred to as pockets, in which cutouts in each case one or more permanent magnet(s) is/are accommodated and then fixed in the cutout. In the case of the electric machine proposed herein, both the first permanent magnet element and the second permanent magnet element can be accommodated in a common cutout. In particular when the two permanent magnet elements have already been connected to one another in advance, similar or identical production processes to those used in electric machines with conventional integral permanent magnets can thus continue to be used.

It is noted that possible features and advantages of embodiments of the invention are described herein sometimes with reference to a permanent magnet electric machine or parts thereof and sometimes with reference to a method for producing such an electric machine. A person skilled in the art will be aware that the various features can be combined with one another or replaced with one another in a suitable manner in order to arrive at further embodiments and possible synergy effects.

### BRIEF DESCRIPTION OF THE DRAWINGS

Embodiments of the present invention will be described below with reference to the drawings, wherein neither the description nor the drawings should be interpreted as being restrictive to the invention.

FIG. 1 shows a perspective view of a rotor for an electric machine according to the invention.

FIG. 2 shows a partial plan view of a rotor of an electric machine according to the invention.

FIG. 3 shows a partial plan view of an alternative rotor for an electric machine according to the invention.

FIG. 4 shows a partial plan view of a further alternative for a rotor for an electric machine according to the invention.

The drawings are merely schematic and are not true to scale.

### DETAILED DESCRIPTION

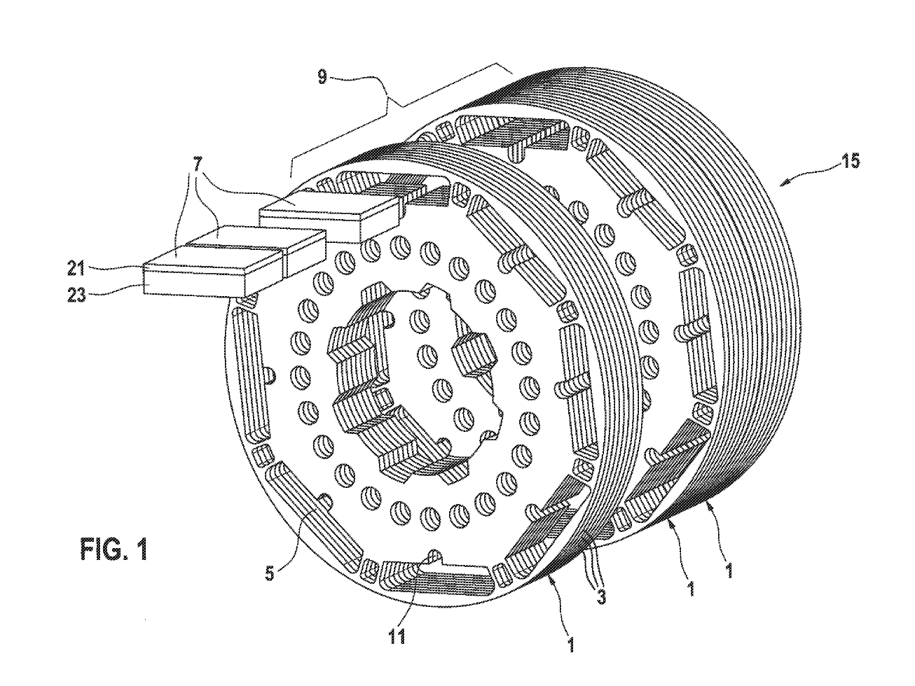

FIG. 1 shows a rotor body 9 of a rotor 15 for a permanent magnet electric machine. In order to improve clarity, the stator of the electric machine is not illustrated in FIG. 1. Given a typical design, the stator surrounds the rotor 15 in the form of a ring and has electromagnets which can be energized in a targeted manner, controlled by a controller of the electric machine.

The rotor body 9 comprises one or more laminate stacks 1, which are in turn formed by a large number of laminations 3 stacked one above the other in the form of thin stamped metal sheets. Substantially rectangular stamped out portions are provided in each of the laminations 3 in a region close to the outer circumference. The laminations 3 stacked one above the other form cutouts 5 within the rotor body 9 by virtue of the stamped out portions arranged in aligned formation.

During assembly of the rotor 15, square permanent magnets 7 are accommodated in the cutouts 5. Alternatively, square bodies consisting of a magnetizable ferromagnetic material can be introduced into the cutouts 5 and subsequently magnetized to produce permanent magnets. The square magnets 7 in this case have a geometry which is substantially identical to the geometry of the cutouts, wherein the magnets 7 are slightly smaller than the cutouts in order to avoid the magnets 7 becoming stuck or caught in the cutouts 5 as said permanent magnets 7 are introduced into the cutouts 5 owing to sufficient lateral play. Then, the magnets 7 can be fixed within the cutouts 5 mechanically or magnetically, for example, by a curable casting compound or adhesive being introduced into remaining cavities 11.

Each of the permanent magnets 7 has a first macroscopic permanent magnet element 21 and a second macroscopic permanent magnet element 23. The first permanent magnet element 21 contains, in addition to a strongly ferromagnetic NdFeB basic material, a significant proportion of dysprosium, and therefore has a high coercivity. The proportion of dysprosium can be, for example, in the range of 5 10 mass %. The second permanent magnet element 23 can likewise have a NdFeB basic material, but without containing a significantly increased coercivity owing to the addition of dysprosium.

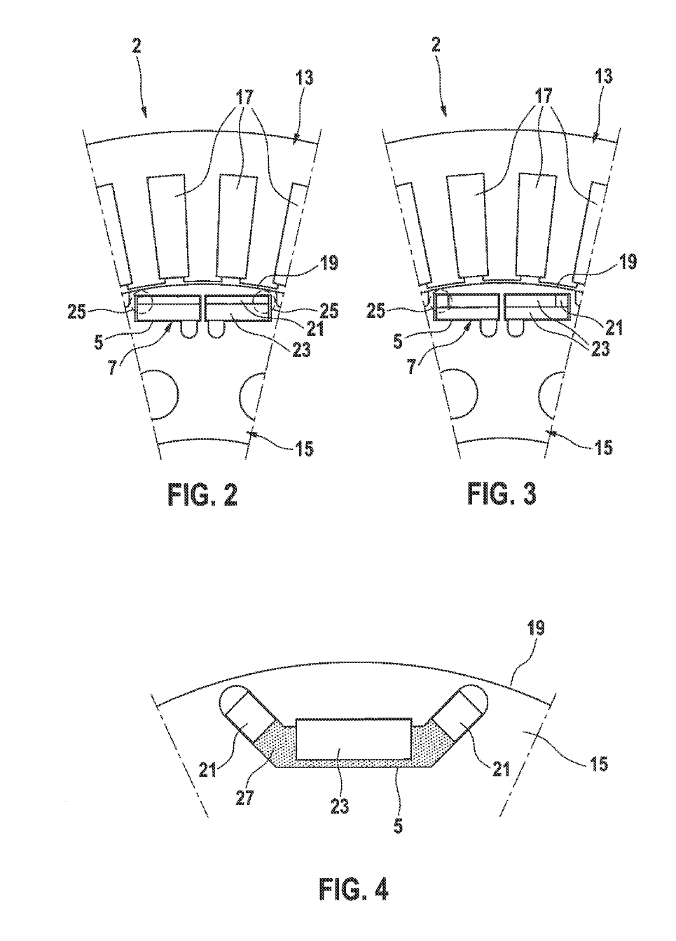

FIGS. 2 and 3 illustrate alternative embodiments of an electric machine 2 with the aid of partial plan views. The electric machine 2 has a stator 13 with electro magnets 17 arranged therein and a rotor 15 capable of rotating within the stator 13. A small air gap 19 is provided between the stator 13 and the rotor 15. The permanent magnets 7 arranged in cutouts 5 are again formed in two parts with a high grade first permanent magnet element 21 and a second permanent magnet element 23 with a relatively low coercivity. The first permanent magnets 21 are in this case arranged closer to the air gap 19 than the second permanent magnet elements 23 since it has been identified that local high temperatures and/or strong magnetic fields or severely fluctuating magnetic fields can occur in particular in the vicinity of such an air gap during operation of the electric machine 2 and therefore demagnetization critical regions 25 occur in the vicinity of this air gap, in which regions there is an increased risk of local demagnetization of magnet material provided there during operation of the electric machine 2.

While in the embodiment shown in FIG. 2, a total flat region of the permanent magnets 7 which is directed toward the gap 19 is formed by a first permanent magnet element 21, in the embodiment shown in FIG. 3 the proportion of expensive, high grade magnet material can be further reduced by virtue of a first permanent magnet element 21 being provided only in edge regions within the cutouts 5, where the distance from the surrounding gap 19 is at its lowest.

FIG. 4 illustrates a further embodiment of a rotor 15 for an electric machine according to the invention. In this embodiment, the cutouts 5 are not square but are approximately V shaped. In end regions of the V shaped cutouts 5, which protrude toward an air gap 19 and are thus closely adjacent to this air gap 19 and the demagnetization critical regions occurring there, first permanent magnet elements 21 with a magnet material having a high coercivity are arranged. Second permanent magnet elements 23 with a relatively low coercivity are arranged in regions of the V shaped cutouts 5 which are further removed from the gap 19. In the example shown in FIG. 4, the first and second permanent magnet elements are not in direct mechanical contact with one another, but are fixed separately within the cutout 5 by a casting compound or adhesive 27.

What is claimed is:

1. A permanent magnet electric machine (2), in which permanent magnets (7) are arranged on at least one of a stator (13) and a rotor (15), characterized in that a permanent magnet (7) has at least one first macroscopic permanent magnet element (21) and one second macroscopic permanent magnet element (23) comprising various materials, which have different magnetic coercivities.

2. The machine according to claim 1, wherein the machine (2) has demagnetization-critical regions (25), in which, during operation of the machine (2), there is an increased probability of demagnetization of a permanent magnet (7) owing to at least one of a high local temperature and strong magnetic fields, wherein a permanent magnet (7) which is arranged partially in a demagnetization-critical region (25) has a first permanent magnet element (21) consisting of a material with a relatively high magnetic coercivity in the demagnetization-critical region (25) and a second permanent magnet element (23) consisting of a material with a relatively low magnetic coercivity outside the demagnetization-critical region (25).

3. The machine according to claim 1, wherein an air gap (19) is provided between the stator (13) and the rotor (15), and wherein a permanent magnet (7), which is arranged in the vicinity of the air gap (19), has a first permanent magnet element (21) consisting of a material with a relatively high magnetic coercivity in a region relatively close to the air gap (19) and a second permanent magnet element (23) consisting of a material with a relatively low magnetic coercitivity in a region relatively far removed from the air gap (19).

4. The machine according to claim 1, wherein the first permanent magnet element (21) contains dysprosium for significantly increasing the coercivity, and wherein the second permanent magnet element (23) does not contain any dysprosium or contains less dysprosium than the first permanent magnet element (21) for significantly increasing the magnetic coercivity.

5. The machine according to claim 2, wherein the first permanent magnet element (21) has a smaller volume than the second permanent magnet element (23).

6. The machine according to claim 1, wherein both the first permanent magnet element (21) and the second permanent magnet element (23) have a volume of at least 1 mm³.

7. The machine according to claim 1, wherein the first and second permanent magnet elements (21, 23) are fixably connected to one another.

8. The machine according to claim 1, wherein the first and second permanent magnet elements (21, 23) are adhesively bonded to one another.

9. The machine according to claim 1, wherein at least one of the rotor (15) and the stator (13) has cutouts (5) for accommodating in each case one permanent magnet (7), wherein both the first permanent magnet element (21) and the second permanent magnet element (23) are accommodated in a common cutout (5).

10. The machine according to claim 2, wherein an air gap (19) is provided between the stator (13) and the rotor (15), and wherein a permanent magnet (7), which is arranged in the vicinity of the air gap (19), has a first permanent magnet element (21) consisting of a material with a relatively high magnetic coercivity in a region relatively close to the air gap (19) and a second permanent magnet element (23) consisting of a material with a relatively low magnetic coercitivity in a region relatively far removed from the air gap (19).

11. The machine according to claim 10, wherein the first permanent magnet element (21) contains dysprosium for significantly increasing the coercivity, and wherein the second permanent magnet element (23) does not contain any dysprosium or contains less dysprosium than the first permanent magnet element (21) for significantly increasing the magnetic coercivity.

12. The machine according to claim 11, wherein the first permanent magnet element (21) has a smaller volume than the second permanent magnet element (23).

13. The machine according to claim 12, wherein both the first permanent magnet element (21) and the second permanent magnet element (23) have a volume of at least 1 mm³.

14. The machine according to claim 13, wherein the first and second permanent magnet elements (21, 23) are fixably connected to one another.

15. The machine according to claim 14, wherein the first and second permanent magnet elements (21, 23) are adhesively bonded to one another.

16. The machine according to claim 15, wherein at least one of the rotor (15) and the stator (13) has cutouts (5) for accommodating in each case one permanent magnet (7), wherein both the first permanent magnet element (21) and the second permanent magnet element (23) are accommodated in a common cutout (5).
